(19) United States
(12) Patent Application Publication
(10) Pub. No.: US 2025/0157049 A1
(43) Pub. Date: May 15, 2025

(54) METHOD AND APPARATUS FOR DETERMINING POSITION OF MOVING OBJECT

(71) Applicant: Electronics and Telecommunications Research Institute, Daejeon (KR)

(72) Inventors: Geon Min YEO, Daejeon (KR); Whui KIM, Daejeon (KR); Young Bag MOON, Seoul (KR); Seong Hee PARK, Daejeon (KR); Juderk PARK, Daejeon (KR); Wun-Cheol JEONG, Daejeon (KR); Tae-Wook HEO, Sejong-si (KR)

(21) Appl. No.: 18/943,793

(22) Filed: Nov. 11, 2024

(30) Foreign Application Priority Data
Nov. 9, 2023 (KR) 10-2023-0154309
Oct. 11, 2024 (KR) 10-2024-0138454

(51) Int. Cl. G06T 7/20; B64U 10/14; B64U 101/30; G01C 11/08; G06V 10/70; H04N 23/695

(52) U.S. Cl. CPC G06T 7/20; B64U 10/14; G01C 11/08; G06V 10/70; H04N 23/695; B64U 2101/30; B64U 2201/104

(57) ABSTRACT

Provided are a method and apparatus for determining a position of a moving object. A method of determining a position of an object includes receiving an image frame from a camera, determining object recognition information of an object included in the image frame by performing object recognition based on deep learning, tracking the object by performing view control of the camera based on the object recognition information, and determining object global positioning system (GPS) position information of the object based on view state information indicating a degree to which the camera is adjusted by the view control.

### CROSS-REFERENCE TO RELATED APPLICATION

This application claims the benefit of Korean Patent Application No. 10-2023-0154309 filed on Nov. 9, 2023 and Korean Patent Application No. 10-2024-0138454 filed on Oct. 11, 2024, in the Korean Intellectual Property Office, the entire disclosures of which are incorporated herein by reference for all purposes.

### BACKGROUND

### 1. Field of the Invention

One or more embodiments relate to a method and apparatus for determining a position of a moving object.

### 2. Description of the Related Art

Object tracking refers to a technology for continuously tracking a position and movement of a specific object in an image sequence. Object tracking is a subfield of computer vision that may be used in a variety of applications. For example, object tracking may be used in autonomous driving vehicles, surveillance systems, sports analytics, augmented reality, and image editing. Deep learning-based artificial intelligence (AI) may be used for object tracking. AI may greatly improve the performance of object tracking.

### SUMMARY

When a surveillance apparatus is fixed and an object to be monitored is out of the field of view of a surveillance apparatus or hidden behind an obstacle, the surveillance accuracy may decrease and it may be difficult to continue surveillance.

According to an aspect, there is provided a method of determining a position of an object, the method including receiving an image frame from a camera, determining object recognition information of an object included in the image frame by performing object recognition based on deep learning, tracking the object by performing view control of the camera based on the object recognition information, and determining object global positioning system (GPS) position information of the object based on view state information indicating a degree to which the camera is adjusted by the view control.

A non-transitory computer-readable storage medium may store instructions that, when executed by a processor, cause the processor to perform the method.

According to an aspect, there is provided a control apparatus for performing object position determination, the control apparatus including one or more processors, and a memory configured to store instructions executable by the one or more processor, in which the instructions, when being executed by the one or more processors, cause the control apparatus to receive an image frame from a camera, determine object recognition information of an object included in the image frame by performing object recognition based on deep learning, track the object by performing view control of the camera based on the object recognition information, and determine object GPS position information of the object based on view state information indicating a degree to which the camera is adjusted by the view control.

Additional aspects of embodiments will be set forth in part in the description which follows and, in part, will be apparent from the description, or may be learned by practice of the disclosure.

According to embodiments, even when an object to be monitored is out of the field of view of a surveillance apparatus or hidden behind an obstacle, surveillance accuracy may be maintained high and continuous surveillance may be possible.

According to embodiments, aerial surveillance and reconnaissance may be performed in conjunction with mobile mission devices such as a drone system. In addition, the embodiments may be applied to various surveillance and reconnaissance applications, including military, such as ground mobility vehicles. Such surveillance reconnaissance may enable continuous surveillance with high accuracy.

According to embodiments, in a surveillance target area, an object may be tracked and object GPS position information may be determined continuously through a system of a simple configuration such as a camera, a view controller, and an object recognition deep learning apparatus.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a configuration of apparatuses for determining a position of a moving object according to an embodiment;

FIG. 2 is a diagram illustrating an example of a specific configuration of apparatuses for determining a position of a moving object according to an embodiment;

FIG. 3 is a diagram illustrating an example of a pan-tilt-zoom (PTZ) control operation in view control of an object tracking system according to an embodiment;

FIG. 4 is a diagram illustrating an example of an operation of an object GPS position information determination system determining image center global positioning system (GPS) position information based on view state information according to PTZ control according to an embodiment;

FIG. 5 is a diagram illustrating an example of an operation of an object GPS position information determination system determining object GPS position information by applying shift values to image center GPS position information according to an embodiment;

FIG. 6 is a flowchart illustrating a method of determining a position of a moving object according to an embodiment; and

FIG. 7 is a block diagram illustrating a configuration of an electronic device for determining a position of a moving object according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that when it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

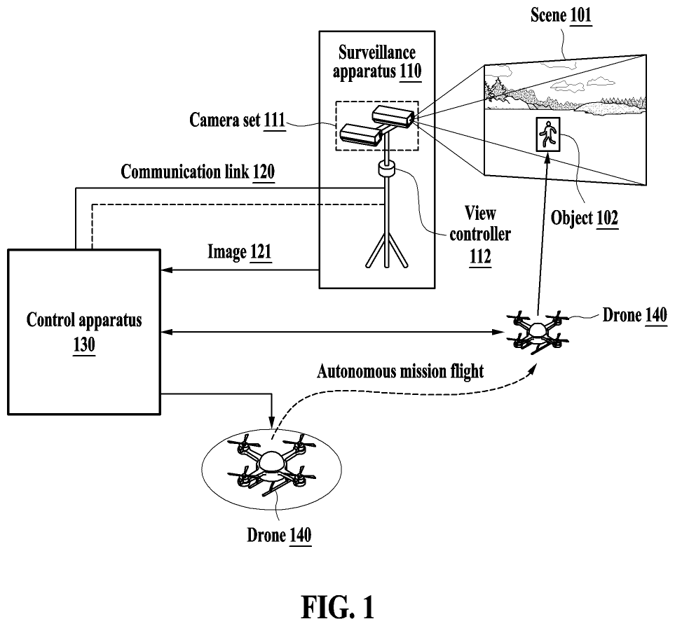

FIG. 1 is a diagram illustrating an example of a configuration of apparatuses for determining a position of a moving object according to an embodiment. Referring to FIG. 1, a control apparatus 130 may receive an image 121 of an object 102 from a surveillance apparatus 110, track the object 102 by performing view control of the surveillance apparatus 110 based on the image 121 captured by the surveillance apparatus 110, and determine a position of the object 102 based on a degree to which the surveillance apparatus 110 is adjusted by the view control. The object 102 may be a moving object having mobility. The image 121 in which the object 102 is captured may correspond to a plurality of image frames. The position of the object 102 determined by the control apparatus 130 may be used to control the flight of a reconnaissance apparatus such as a drone 140.

The surveillance apparatus 110 may capture the object 102 included in a specific scene 101. The surveillance apparatus 110 may include a camera set 111, and a view controller 112 for controlling a view of the camera set 111. The camera set 111 may include one or more cameras. For example, the camera set 111 may include a visible light camera (e.g., an electro-optical (EO) camera) for recognizing objects during the day using a visible light band, and an infrared (IR) camera for recognizing objects at night using infrared rays, but is not limited thereto. For example, the camera set 111 may be an EO/IR camera in which an EO camera and an IR camera are combined.

The view controller 112 may perform the view control to adjust the camera set 111. The view control may be performed to continuously track the object 102 in the scene 101 captured by the camera set 111. For example, when the object 102 continues to move to the left, the view controller 112 may perform the view control to rotate the camera set 111 to the left so that the object 102 may be captured in the scene 101. The view controller 112 may receive a view control signal from the control apparatus 130. For example, when the object 102 continues to move to the left within the image 121, the view controller 112 may receive a view control signal indicating to rotate the camera set 111 to the left, from the control apparatus 130.

It may be essential to exactly determine the position of the object 102 for the control apparatus 130 to cause the reconnaissance apparatus such as the drone 140 to approach the object 102 and perform a mission. When the exact position of the object 102 is not determined, the reconnaissance apparatus may not be able to effectively approach a target point. For example, in a case of the drone 140, a lot of time may be spent searching for the object 102, and the mission may not be completed due to battery limitations. In addition, since the object 102 (e.g., a person, a drone, an animal, a vehicle, a tank, or the like) has mobility, continuous object tracking may be required to perform a mission of the reconnaissance apparatus such as the drone 140. For example, for object tracking and determining position of an object moving at a relatively high speed, such as a vehicle or drone, precise view control may be required to ensure that the object does not leave an image of the surveillance apparatus 110. The control apparatus 130 may track the object 102 and determine the position of the object 102 by adjusting the surveillance apparatus 110 to perform precise view control.

The control apparatus 130 may receive the image 121 from the surveillance apparatus 110, and determine information about the object 102 included in the image 121. The control apparatus 130 may perform object tracking based on information about the object 102 so that the object 102 does not leave the scene 101 being captured by the surveillance apparatus 110. The control apparatus 130 may transmit the view control signal to the view controller 112 of the surveillance apparatus 110 to perform the object tracking, and the view controller 112 that receives the view control signal may perform the view control.

The control apparatus 130 may determine a degree to which the surveillance apparatus 110 is adjusted by performing the view control. In an embodiment, the control apparatus 130 may determine the degree to which the surveillance apparatus 110 is adjusted based on view state information provided by the view controller 112 of the surveillance apparatus 110. In another embodiment, the control apparatus 130 may determine the degree to which the surveillance apparatus 110 is adjusted based on the view control signal transmitted to the view controller 112 of the surveillance apparatus 110. When the control apparatus 130 receives the image 121 and the view state information from the surveillance apparatus 110 and the control apparatus 130 transmits the view control signal to the surveillance apparatus 110, a communication link 120 may be used. The communication link 120 may be a wired communication link, a wireless communication link, or a combination thereof. The control apparatus 130 may determine the position of the object 102 based on the degree to which the surveillance apparatus 110 is adjusted. Position information of the determined object 102 may include global positioning system (GPS) position information. Such GPS position information may be referred to as object GPS position information.

Since the surveillance apparatus 110 captures the object 102 from a fixed position, there may be limitations in tracking the object 102 in situations such as when the object 102 moves away from the surveillance apparatus 110, when the object 102 is hidden behind an obstacle that blocks the view of the surveillance apparatus 110, or the like. The object GPS position information may be used to complement tracking limitations due to the fixed position of the surveillance apparatus 110. For example, object GPS position information may be provided to, but is not limited to, a reconnaissance apparatus such as the drone 140, reconnaissance equipment used by humans with the same reconnaissance mission, or other surveillance apparatuses positioned far from the surveillance apparatus 110.

For example, the reconnaissance apparatus such as the drone 140 may receive a flight mission instruction from the control apparatus 130 and perform autonomous mission flight. The autonomous mission flight may refer to an operation in which the drone 140 flies autonomously with minimal user intervention to reach a destination. The drone 140 may include a camera set and a view controller, such as the surveillance apparatus 110. The drone 140 may communicate with the control apparatus 130 to provide information about the object 102 or receive information about the object 102. In an embodiment, the flight mission of the drone 140 may be a surveillance mission to assist in the surveillance of the surveillance apparatus 110. For example, the drone 140 may fly to the position of the object 102 and perform a surveillance mission of the object 102 together with the surveillance apparatus 110 before the object 102 leaves an area that the surveillance apparatus 110 may capture. In another embodiment, the flight mission of the drone 140 may be a warning mission linked to the surveillance of the surveillance apparatus 110. For example, when a person, a vehicle, or the like is captured by the surveillance apparatus 110, a warning mission of approaching the object 102 and notifying not to enter may be performed.

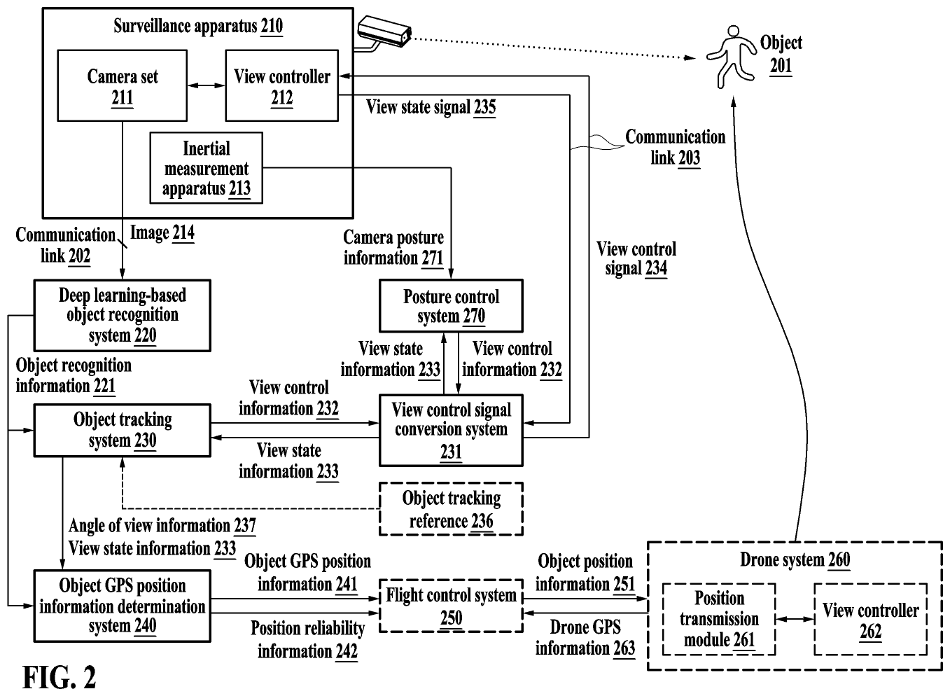

FIG. 2 is a diagram illustrating an example of a specific configuration of apparatuses for determining a position of a moving object according to an embodiment. Referring to FIG. 2, a position of an object 201 may be determined using at least one of a surveillance apparatus 210, a deep learning-based object recognition system 220, an object tracking system 230, a view control signal conversion system 231, an object GPS position information determination system 240, a flight control system 250, and an posture control system 270. The surveillance apparatus 210, the deep learning-based object recognition system 220, the object tracking system 230, the view control signal conversion system 231, the object GPS position information determination system 240, the flight control system 250, and the posture control system 270 may be referred to as an object position determination system.

The object 201 may be a moving object having mobility. One or more of the deep learning-based object recognition system 220, the object tracking system 230, the view control signal conversion system 231, the object GPS position information determination system 240, the flight control system 250, and the posture control system 270 of FIG. 2 may be included in the control apparatus 130 of FIG. 1.

The surveillance apparatus 210 may include a camera set 211, a view controller 212, and an inertial measurement apparatus 213, and the surveillance apparatus 210 may correspond to the surveillance apparatus 110 of FIG. 1. The view controller 212 may be a controller that controls the view of the camera set 211. In an embodiment, the view controller 212 may be a pan-tilt-zoom (PTZ) controller that controls the PTZ of the camera set 211. In an embodiment, the inertial measurement apparatus 213 may include sensors (e.g., a gyroscope, an accelerometer, a geomagnetic sensor, and the like) for orienting the camera set 211 in a horizontal and due north direction.

The deep learning-based object recognition system 220 may recognize the object 201 in an image 214 captured by the surveillance apparatus 210. The deep learning-based object recognition system 220 may perform object recognition using artificial intelligence (AI). For example, AI using a neural network may be used. The neural network may be trained to recognize a given object from an input image using deep learning.

The deep learning-based object recognition system 220 may receive the image 214 from the surveillance apparatus 210 through a communication link 202. The image 214 received by the deep learning-based object recognition system may be a video including a plurality of consecutive image frames (e.g., an image frame sequence). The communication link 202 may be a wired communication link, a wireless communication link, or a combination thereof. The deep learning-based object recognition system 220 may recognize the object 201 in the received image 214 based on deep learning. In an embodiment, the deep learning-based object recognition system 220 may recognize the object 201 within each image frame of the plurality of image frames.

The deep learning-based object recognition system 220 may determine object recognition information 221 based on the recognized object 201. The object recognition information 221 may include information used to track the object 201 and determine the position of the object. For example, the object recognition information 221 may include information about an object bounding box of the object 201 (e.g., an x-coordinate, a y-coordinate, a box size of the bounding box, and the like), information about an actual size of the object (e.g., an average size of the recognized object and the like), an image resolution, and the like. In an embodiment, the deep learning-based object recognition system 220 may determine the object recognition information 221 within each image frame of the plurality of image frames. The deep learning-based object recognition system 220 may transmit the object recognition information 221 to the object tracking system 230 and the object GPS position information determination system 240.

The object tracking system 230 may track the object 201 by adjusting the surveillance apparatus 210 based on the object recognition information 221. The object tracking system 230 may track the object 201 by causing the view controller 212 of the surveillance apparatus 210 to perform the view control. The object tracking system 230 may track the object 201 according to an object tracking reference 236.

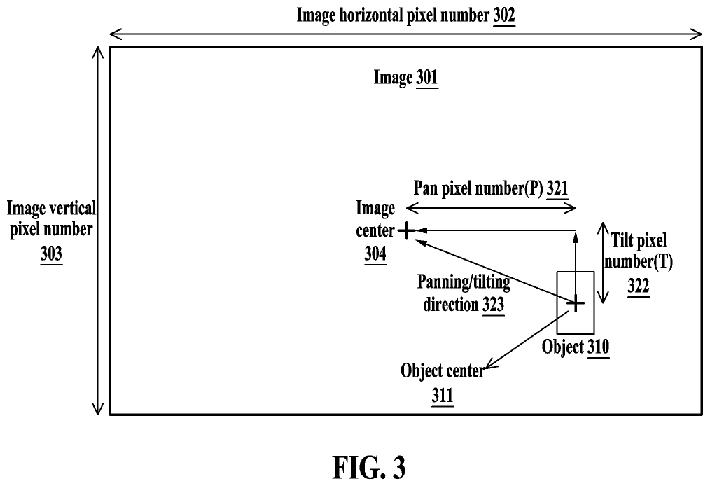

For example, the object tracking reference 236 may be, but is not limited to, adjusting the camera set 211 so that the object 201 is positioned at the center of the image 214 and adjusting zooming so that a size of an object bounding box is maintained at a predetermined size. For example, the object tracking system 230 may adjust panning and tilting of the camera set 211 so that the object 201 is positioned at the center of the image 214 according to the object tracking reference 236, and adjust the zooming of the camera set 211 so that the box size of the object bounding box remains constant. Hereinafter, PTZ control which is one embodiment of the view control will be described in detail with reference to FIG. 3.

Even when the object tracking system 230 performs the view control (e.g., the PTZ control) in response to a first image frame, the object tracking reference 236 may not be satisfied within a second image frame as the object 201 moves. Accordingly, the object tracking system 230 may need to re-perform the view control corresponding to the second image frame. For example, the object tracking system may re-perform the view control of the camera so that the object 201 is positioned at the center of the second image frame and the box size of the object bounding box within the second image frame becomes a predetermined size, based on the object recognition information 221 corresponding to the second image frame and view state information 233 corresponding to the first image frame. The object recognition information 221 corresponding to the second image frame may be referred to as second object recognition information. In an embodiment, the view state information 233 corresponding to the second image frame may be determined by updating a relative value indicating a degree to which the view control corresponding to the second image frame is performed to the view state information 233 corresponding to the first image frame. In another embodiment, the view state information 233 corresponding to the second image frame may be determined based on an absolute value indicating the degree to which the view control corresponding to the second image frame is performed.

The view control signal conversion system 231 may receive view control information 232 from the object tracking system 230. The view control information 232 may include information for adjusting the camera set 211 for object tracking. The view control signal conversion system 231 may generate a view control signal 234 that may be recognized by the view controller based on the view control information 232. The view control signal conversion system 231 may transmit the view control signal 234 to the view controller 212. The view control signal conversion system 231 may receive a view state signal 235 generated by the view controller 212. The view control signal conversion system 231 may convert the view state signal 235 to generate the view state information 233. The view state information 233 may indicate the degree to which the view control of the camera set 211 is performed.

In an embodiment, the view state information 233 may be PTZ state information, and the view control information 232 may be PTZ control information. For example, the view state information 233 may include values indicating a degree to which the camera set 211 is currently panned, tilted, or zoomed. In addition, for example, the view control information 232 may include a value indicating the degree to which the camera set 211 needs to be panned, tilted, or zoomed, and the degree to which the camera set 211 needs to be panned, tilted, or zoomed may be an absolute value or a relative value based on the view state information 233.

In an embodiment, the view control signal conversion system 231 may be included in the object tracking system 230. In another embodiment, the signal transmission between the view control signal conversion system 231 and the view controller 212 may be performed via a communication link 203. The communication link 203 may be a wired communication link, a wireless communication link, or a combination thereof, like the communication link 202. The view control signal conversion system 231 may receive the view control information 232 from the posture control system 270, and transmit the view state information 233 to the posture control system 270.

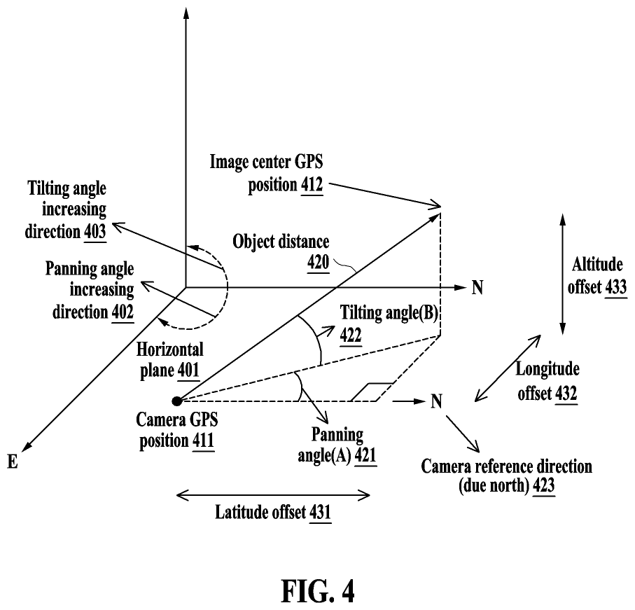

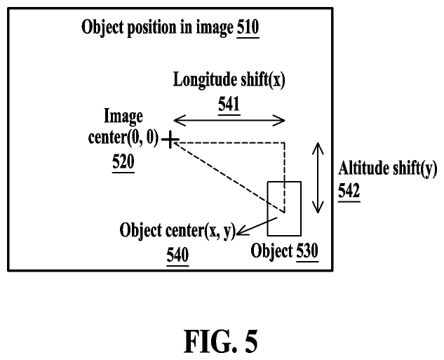

The object GPS position information determination system 240 may determine the position of the object 201. The object GPS position information determination system 240 may receive the view state information 233 and angle of view information 237 from the object tracking system 230. In an embodiment, the view state information 233 may include the angle of view information 237. In an embodiment, the angle of view information 237 may be determined based on the degree to which the camera set 211 is zoomed. In an embodiment, the object GPS position information determination system may determine object GPS position information 241 of the object 201 by determining GPS position information of the center of the image 214. For example, when the object tracking system 230 performs object tracking so that the object 201 is positioned at the center of the image 214, the determined GPS position information of the center of image 214 may be the same as the object GPS position information 241. In another embodiment, the position (e.g., object GPS position information) of the object 201 may be determined by determining image center position information (e.g., image center GPS position information) of the center of the image 214, and performing a GPS shift based on the image center position information. Hereinafter, the operation of determining the object GPS position information based on the view state information according to the PTZ control will be described in detail with reference to FIGS. 4 and 5.

Despite the object tracking by the object tracking system 230, the image center GPS position information at the center of the image 214 and the object GPS position information 241 may not be the same. In an embodiment, the view state information 233 and the angle of view information received by the object GPS position information determination system 240 may be view state information and angle of view information corresponding to an initial image frame (which may be referred to as the first image frame), and the object recognition information 221 received by the object GPS position information determination system 240 may be object recognition information corresponding to an n-th image frame (n may have a value greater than 1) due to a time difference. For example, when the object recognition information 221 received by the object GPS position information determination system 240 by the time difference corresponds to the second image frame and the view state information 233 corresponds to the first image frame, the object 201 in the second image frame may not be positioned at the center of the second image frame despite the object tracking of the object tracking system 230 corresponding to the first image frame. The time difference may be generated due to the time taken to capture the first image frame and the second image frame and/or the time for the view control performed by the view controller 212.

The view state information 233 may indicate a degree to which the camera set 211 of the surveillance apparatus 210 is adjusted based on a specific reference point. The posture control system 270 may set a reference point of the degree to which the camera set 211 is adjusted. The posture control system 270 may receive camera posture information 271 from the inertial measurement apparatus 213 of the surveillance apparatus 210 before tracking the object 201 and perform view control by adjusting the position of the camera set 211. For example, the posture control system 270 may perform PTZ control by adjusting the camera set 211 until the horizontal and due north orientation of the camera set 211 is completed. In addition, for example, when the horizontal and due north orientation of the camera set 211 is completed, the posture control system may set current panning and tilting values to 0 with a current position as the reference point.

The flight control system 250 may be an exemplary application system based on a position determined by the object GPS position information determination system 240. The flight control system 250 may receive the object GPS position information 241 and position reliability information 242 from the object GPS position information determination system 240. The flight control system 250 may determine object position information 251 based on the object GPS position information 241 and the position reliability information 242. For example, the object position information 251 may be determined by adding an error based on the object GPS position information 241 and the position reliability information 242. A drone system 260 may include the drone 140 of FIG. 1.

The flight control system may transmit the object position information 251 to the drone system 260 via a wireless communication link. The drone system 260 may perform a flight to the position of the object 201 based on the object position information 251. The drone system 260 may include a position transmission module 261 and a view controller 262. The drone system 260 may image the object 201 through a camera attached to the drone system 260. The view controller 262 may perform the view control of the camera attached to the drone system 260. In an embodiment, the view controller 262 of the drone system 260 may be controlled by the object tracking system 230.

Drone GPS information 263 including information about the object 201 may be transmitted to the flight control system 250 by the position transmission module 261. In an embodiment, the flight control system 250 may generate the object position information 251 by comparing the drone GPS information 263 received from the drone system 260 with the object GPS position information 241. The flight control system 250 may control the flight by transmitting the object position information 251 generated based on the drone GPS information 263 to the drone system 260.

FIG. 3 is a diagram illustrating an example of a PTZ control operation in view control of an object tracking system according to an embodiment. Referring to FIG. 3, the object tracking system adjusts panning and tilting of a camera through a PTZ controller of a surveillance apparatus so that an object center 311 of an object 310 is positioned at an image center 304. The object center 311 may represent a box center of a bounding box of the object 310. The PTZ controller may correspond to the view controller 112 of FIG. 1 and the view controller 212 of FIG. 2. In an embodiment, the object tracking system may track the object 310 by adjusting the panning and tilting through the PTZ controller to make the center of an object bounding box coincide with the center of an image 301. In addition, for example, the object tracking system may track the object 310 by adjusting the zoom through the PTZ controller so that a box size of the object bounding box is a predetermined size.

A panning angle A and a tilting angle B, which are the degrees to which the object tracking system adjusts the panning and tilting of the camera so that the center of the object bounding box coincides with the center of the image 301, may be determined through Equations 1 and 2 based on a current angle of view after zoom adjustment.

$$A = fov\_w \cdot \frac{P}{image\_size \_w} + α , α \geq 0 \qquad [ Equation 1 ]$$

$$B = fov\_h \cdot \frac{T}{image\_size \_h} + β , β \geq 0 \qquad [ Equation 2 ]$$

A may represent a panning angle, and B may represent a tilting angle. P and T may represent the number of pan pixels 321 and the number of tilt pixels 322 from the object center 311 of the object 310 to the image center 304, respectively. image_size_h and image_size_w may represent an image vertical pixel number 303 and an image horizontal pixel number 302, respectively. The image vertical pixel number 303 and the image horizontal pixel number 302 may be included in the object recognition information 221 of FIG. 2. α and β may be values dynamically applied within the object tracking system by considering speed and movement directions of the object 310. For example, when the object 310 moves quickly to the right from the image center 304, a positive value may be applied to a, and a value of 0 may be applied to β.

fov_w may represent a horizontal angle of view of the camera, and fow_h may represent a vertical angle of view of the camera. In an embodiment, the angle of view information 237 of FIG. 2 may include a horizontal angle of view and a vertical angle of view. In an embodiment, one or more cameras forming a camera set of a surveillance apparatus may provide a current zoom value and a focal length. In an embodiment, the angle of view information 237 may be determined based on the degree of zooming performed by the view controller 212. In an embodiment, when a focal length is provided, the horizontal angle of view and the vertical angle of view may be determined through Equations 3 and 4.

$$fov\_w = a tan ( \frac{sensor\_size \_w}{fl} ) \qquad [ Equation 3 ]$$

$$fov\_h = fov\_w \cdot \frac{image\_size \_h}{image\_size \_w} \qquad [ Equation 4 ]$$

fl and sensor_size_w may represent a focal length of a camera and a horizontal size of an image sensor of the camera, respectively. In another embodiment, when a focal length is not provided, a focal length may be determined directly by Equation 5.

$$fl = ( zoom - 1 ) \cdot \frac{( fl\_max - fl\_min )}{( zoom\_max - zoom\_min )} + fl\_min \qquad [ Equation 5 ]$$

fl_max and fl_min may represent a maximum focal length and a minimum focal length, respectively. zoom max and zoom_min may represent a maximum zoom value and a minimum zoom value, respectively. Zoom may indicate a current zoom value.

Even when the object tracking system performs the PTZ control in response to a first image frame, the object center 311 and the image center 304 within a second image frame may not coincide as the object 310 moves. Accordingly, the object tracking system may need to re-perform the PTZ control corresponding to the second image frame. For example, the object tracking system may re-perform the PTZ control of the camera so that the object 310 is positioned at the center of the second image frame and the box size of the object bounding box within the second image frame becomes a predetermined size, based on object recognition information corresponding to the second image frame and PTZ state information indicating the degree to which the camera is PTZ-ed corresponding to the first image frame.

FIG. 4 is a diagram illustrating an example of an operation of an object GPS position information determination system determining image center GPS position based on view state information according to PTZ control according to an embodiment. Referring to FIG. 4, the object GPS position information determination system determines an image center GPS position 412 by applying offsets 431, 432, and 433 to a camera GPS position 411. The object GPS position information determination system may determine information about the camera GPS position 411 and an object distance 420. The object GPS position information determination system may determine the offsets 431, 432, and 433 based on the object distance 420, a panning angle 421, and a tilting angle 422.

In an embodiment, the object GPS position information determination system may predetermine the camera GPS position 411. The object GPS position information determination system may receive the panning angle A 421 and the tilting angle B 422, which are the degrees to which the panning and tilting of the camera are adjusted according to the PTZ control, as view state information. The panning angle 421 and the tilting angle 422 may be measured along certain directions 402 and 403 from references 401 and 423 determined by the posture control system 270 of FIG. 2. The object GPS position information determination system may use Equation 6 and/or Equation 7 to determine the object distance 420 to be used to determine the offsets 431, 432, and 433.

$$distance = \frac{object\_size \_w \cdot image\_size \_w}{2 \cdot tan ( fov\_w / 2 ) \cdot bb\_wize \_w} \qquad [ Equation 6 ]$$

$$distance = \frac{object\_size \_h \cdot image\_size \_h}{2 \cdot tan ( fov\_h / 2 ) \cdot bb\_wize \_h} \qquad [ Equation 7 ]$$

distance may represent the object distance 420. object_size_w and object_size_h may represent the number of horizontal pixels and the number of vertical pixels of an actual size of an object included in object recognition information, respectively. bb_size_w and bb_size_h may represent the number of horizontal pixels and the number of vertical pixels of a box size of an object bounding box of a moving object, respectively.

The latitude offset 431 may be determined by multiplying the object distance 420 by cos(B), cos(A), and (a latitude difference value per object distance unit, diff_LAT). The longitude offset 432 may be determined by multiplying the object distance 420 by cos(B), sin(A), and (a longitude difference per object distance unit, diff_LON). The altitude offset 433 may be determined by multiplying the object distance 420 by sin(B) and (an altitude difference per object distance unit, diff_ALT). The object GPS position determination system may determine the image center GPS position 412 by adding the determined latitude, longitude, and altitude offsets 431, 432, and 433 to the latitude, longitude, and altitude of the camera GPS position 411.

FIG. 5 is a diagram illustrating an example of an operation of an object GPS position information determination system determining object GPS position information by applying shift values to image center GPS position information according to an embodiment. Referring to FIG. 5, the object GPS position information determination system may determine shift values 541 and 542 based on a distance between an image center 520 and an object center 540 of a moving object 530. The shift values 541 and 542 may indicate a degree to which the object center 540 deviates from the image center 520. The object GPS position information determination system may determine the object GPS position information of the moving object 530 by applying the shift values 541 and 542 to the image center GPS position information.

In an embodiment, the view state information and the object recognition information received by the GPS position information determination system may not correspond to the same image frame due to a time difference. For example, the object recognition information received by the object GPS position information determination system may correspond to a second image frame, and the view state information may correspond to a first image frame. Accordingly, even when the PTZ control is performed, the object center 540 of the object 530 in an image corresponding to the second image frame or the like may not match the image center 520.

In an embodiment, the shift values 541 and 542 may be determined as the coordinates of the object center (x, y) 540 after setting the coordinates of the image center 520 to (0,0). In an embodiment, when a current direction, in which the panning of a camera is adjusted, is very close to due north or due south, the shift values 541 and 542 may correspond to a longitude shift or an altitude shift. In another embodiment, when the current direction, in which the panning of a camera is adjusted, is very close to due east or due west, the shift values 541 and 542 may correspond to a latitude shift and an altitude shift. FIG. 5 shows an embodiment in which the direction of the camera is close to due north, and the shift values 541 and 542 correspond to the longitude shift 541 and the altitude shift 542. In an embodiment, when the current direction of the camera is very close to due north, object GPS position information p, X, and h may be determined by applying the shift values (x, y) 541 and 542 to the image center GPS position information LAT, LON, and ALT through Equation 8. φ may represent the latitude of the object GPS, k may represent the longitude of the object GPS, and h may represent the altitude of the object GPS.

$$( φ , λ , h ) = ( LAT + cos ( A ) cos ( B ) distance \cdot diff\_LAT + 0 ) + ( LON + ( sin ( A ) cos ( B ) + sin ( fov\_w / 2 ) ( 2 x / image\_size \_w ) ) \cdot distance \cdot diff\_LON ) + ( ALT + ( sin ( B ) + sin ( fov\_h / 2 ) ( 2 y / image\_size \_w ) ) \cdot distance \cdot diff\_ALT ) \qquad [ Equation 8 ]$$

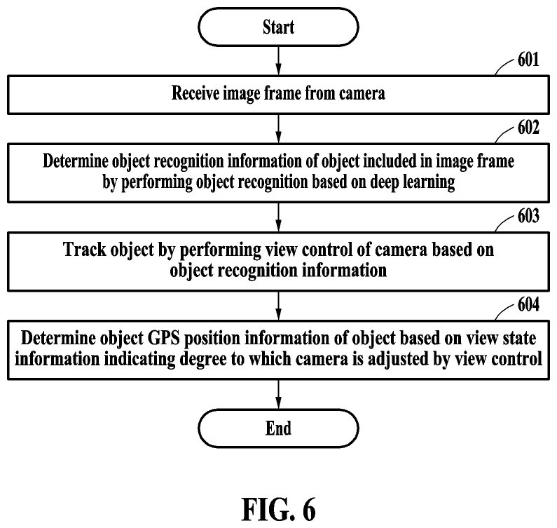

FIG. 6 is a flowchart illustrating a method of determining a position of a moving object according to an embodiment. Referring to FIG. 6, in operation 601, a control apparatus receives an image frame from a camera. The control apparatus may receive a second image frame from the camera. The control apparatus may control a flight of a drone system based on object GPS position information. The control apparatus may control the flight of the drone system based on drone GPS information obtained from the drone system.

In operation 602, the control apparatus determines object recognition information of an object included in an image frame by performing object recognition based on deep learning. The object recognition information may include information about an object bounding box of an object. The control apparatus may determine second object recognition information of an object included in a second image frame by performing object recognition based on deep learning. The second object recognition information may include information about a second object bounding box of an object.

In operation 603, the control apparatus tracks the object by performing view control of the camera based on the object recognition information. The control apparatus may perform the view control of the camera so that the object is positioned at the center of the image frame and the box size of the object bounding box is a predetermined size. The control apparatus may position the object at the center of the image frame by adjusting the panning and tilting of the camera based on a distance between the center of the image frame and a center of the object bounding box and an angle of view of the camera. The control apparatus may re-perform the view control based on the view state information so that the object is positioned at the center of the second image frame and a second box size of the second object bounding box becomes a predetermined size. The control apparatus may generate a view control signal that may be recognized by a view controller that performs view control of a camera. The view state information may be generated by converting a view state signal generated by the view controller.

In operation 604, the control apparatus determines object GPS position information of the object based on the view state information indicating a degree to which the camera is adjusted by the view control. The control apparatus may determine the object GPS position information based on the second object recognition information. The control apparatus may determine image center GPS position information of the center of the second image frame based on the view state information and the second object recognition information. The control apparatus may determine the object GPS position information based on the second object recognition information and the image center GPS position information. The control apparatus may determine an object distance between a camera and an object. The control apparatus may determine offsets based on the object distance. The control apparatus may determine the image center GPS position information of the center of the second image frame by applying the offsets to camera GPS position information of the camera. The control apparatus may determine shift values based on a distance between the center of the second image frame and the center of the second object bounding box. The control apparatus may determine the object GPS position information by applying the shift values to the image center GPS position information.

In addition, the description of FIGS. 1 to 5 may be applied to a method of determining a position of an object.

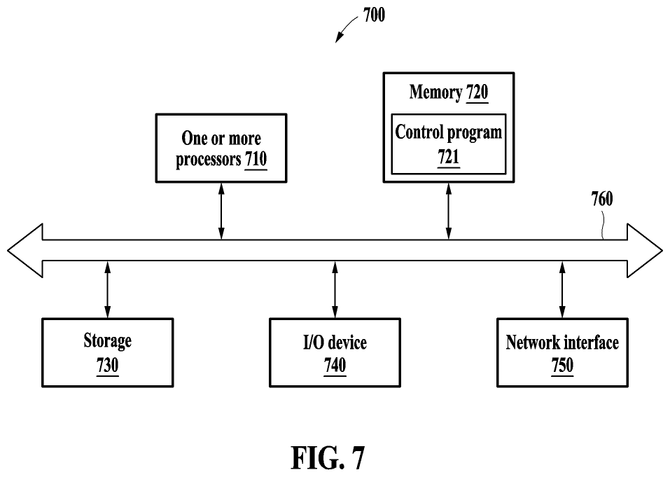

FIG. 7 is a block diagram illustrating a configuration of an electronic device for determining a position of a moving object according to an embodiment. Referring to FIG. 7, an electronic device 700 may include one or more processors 710, a memory 720, a storage 730, an input/output (I/O) device 740, and a network interface 750. These components may communicate with each other via a communication bus 760.

When the control apparatus of FIG. 1 is implemented as a single component, the electronic device 700 may correspond to the control apparatus. When the control apparatus of FIG. 1 is implemented with a plurality of components such as the deep learning-based object recognition system 220, the object tracking system 230, the view control signal conversion system 231, the object GPS position information determination system, the flight control system 250, and the posture control system 270 of FIG. 2, the electronic device 700 may correspond to each of the plurality of components.

The one or more processors 710 may execute instructions stored in the memory 720 or the storage 730. When executed by the one or more processors 710, the instructions may cause the electronic device 700 to perform the operations described with reference to FIGS. 1 to 6. The memory 720 may include a non-transitory computer-readable storage medium or a non-transitory computer-readable storage device. The memory 720 may store instructions to be executed by the one or more processors 710 and may store related information while software and/or an application is being executed by the electronic device 700. The memory 720 may store a control program 721 that performs position determination of a moving object in an embodiment. When at least a portion of the control program 721 is stored in the memory 720, the operations described with reference to FIGS. 1 to 6 may be performed by the electronic device 700.

When the control apparatus of FIG. 1 is implemented as a single component, the control program 721 may be stored in the memory 720 of the electronic device 700 corresponding to the control apparatus, and when the control apparatus of FIG. 1 is implemented as a plurality of components, the control program 721 may be distributed and stored in the memory 720 of the electronic device 700 corresponding to each of the plurality of components.

The storage 730 may include a computer-readable storage medium or a computer-readable storage device. The storage 730 may store a more quantity of information than the memory 720 for a long time. For example, the storage 730 may include a magnetic hard disk, an optical disc, a flash memory, a floppy disk, or other non-volatile memories known in the art.

The I/O device 740 may receive an input from the user in traditional input manners through a keyboard and a mouse, and in new input manners such as a touch input, a voice input, and an image input. For example, the I/O device 740 may include a keyboard, a mouse, a touch screen, a microphone, or any other device that detects the input from the user and transmits the detected input to the electronic device 700. The I/O device 740 may provide an output of the electronic device 700 to the user through a visual, auditory, or haptic channel. The I/O device 740 may include, for example, a display, a touch screen, a speaker, a vibration generator, or any other device that provides the output to the user. The network interface 750 may communicate with an external device via a wired or wireless network.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording media.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of determining a position of an object, the method comprising:
receiving an image frame from a camera;
determining object recognition information of an object included in the image frame by performing object recognition based on deep learning;
tracking the object by performing view control of the camera based on the object recognition information; and
determining object global positioning system (GPS) position information of the object based on view state information indicating a degree to which the camera is adjusted by the view control.

2. The method of claim 1, wherein
the object recognition information comprises information about an object bounding box of the object, and
the tracking of the object comprises performing the view control of the camera so that the object is positioned at a center of the image frame and a box size of the object bounding box is a predetermined size.

3. The method of claim 2, wherein the performing of the view control comprises positioning the object at the center of the image frame by adjusting panning and tilting of the camera based on a distance between the center of the image frame and a center of the object bounding box and an angle of view of the camera.

4. The method of claim 2, further comprising:
receiving a second image frame following the image frame from the camera; and
determining second object recognition information of the object included in the second image frame by performing the object recognition based on the deep learning,
wherein the second object recognition information comprises information about a second object bounding box of the object, and
the tracking of the object comprises reperforming the view control of the camera based on the view state information so that the object is positioned at a center of the second image frame and a second box size of the second object bounding box is the predetermined size.

5. The method of claim 1, wherein
the tracking of the object comprises generating a view control signal recognizable by a view controller that performs the view control of the camera, and
the view state information is generated by converting a view state signal generated by the view controller.

6. The method of claim 1, further comprising:
receiving a second image frame following the image frame from the camera; and
determining second object recognition information of the object included in the second image frame by performing the object recognition based on the deep learning,
wherein the determining of the object GPS position information is performed further based on the second object recognition information.

7. The method of claim 6, wherein the determining of the object GPS position information comprises:
determining image center GPS position information of a center of the second image frame based on the view state information and the second object recognition information; and
determining the object GPS position information based on the second object recognition information and the image center GPS position information.

8. The method of claim 7, wherein the determining of the image center GPS position information comprises:
determining an object distance between the camera and the object;
determining offsets based on the object distance; and
determining the image center GPS position information of the center of the second image frame by applying the offsets to camera GPS position information of the camera.

9. The method of claim 7, wherein
the second object recognition information comprises information about a second object bounding box of the object, and
the determining of the object GPS position information based on the image center GPS position information comprises:
determining shift values based on a distance between the center of the second image frame and a center of the second object bounding box; and
determining the object GPS position information by applying the shift values to the image center GPS position information.

10. The method of claim 1, further comprising:
controlling a flight of a drone system based on the object GPS position information.

11. The method of claim 10, wherein the controlling of the flight of the drone system is performed further based on drone GPS information obtained from the drone system.

12. A non-transitory computer-readable storage medium storing instructions that, when executed by a processor, cause the processor to perform the method of claim 1.

13. A control apparatus for performing object position determination, the control apparatus comprising:
one or more processors; and
a memory configured to store instructions executable by the one or more processor,
wherein the instructions, when being executed by the one or more processors, cause the control apparatus to:
receive an image frame from a camera;
determine object recognition information of an object included in the image frame by performing object recognition based on deep learning;
track the object by performing view control of the camera based on the object recognition information; and
determine object global positioning system (GPS) position information of the object based on view state information indicating a degree to which the camera is adjusted by the view control.

14. The control apparatus of claim 13, wherein
the object recognition information comprises information about an object bounding box of the object, and
the instructions, when being executed by the one or more processors, cause the control apparatus to, in order to track the object, perform the view control of the camera so that the object is positioned at a center of the image frame and a box size of the object bounding box is a predetermined size.

15. The control apparatus of claim 14, wherein the instructions, when being executed by the one or more processors, cause the control apparatus to, in order to perform the view control, position the object at the center of the image frame by adjusting panning and tilting of the camera based on a distance between the center of the image frame and a center of the object bounding box and an angle of view of the camera.

16. The control apparatus of claim 13, wherein the instructions, when being executed by the one or more processors, cause the control apparatus to:
receive a second image frame following the image frame from the camera;
determine second object recognition information of the object included in the second image frame by performing the object recognition based on the deep learning; and
determine the object GPS position information further based on the second object recognition information.

17. The control apparatus of claim 16, wherein the instructions, when being executed by the one or more processors, cause the control apparatus to, in order to determine the object GPS position information:
determine image center GPS position information of a center of the second image frame based on the view state information and the second object recognition information; and
determine the object GPS position information based on the second object recognition information and the image center GPS position information.

18. The control apparatus of claim 17, wherein the instructions, when being executed by the one or more processors, cause the control apparatus to, in order to determine the image center GPS position information:
determine an object distance between the camera and the object;
determine offsets based on the object distance; and
determine the image center GPS position information of the center of the second image frame by applying the offsets to camera GPS position information of the camera.

19. The control apparatus of claim 17, wherein
the second object recognition information comprises information about a second object bounding box of the object, and
the instructions, when being executed by the one or more processors, cause the control apparatus to, in order to determine the object GPS position information based on the image center GPS position information:
determine shift values based on a distance between the center of the second image frame and a center of the second object bounding box; and
determine the object GPS position information by applying the shift values to the image center GPS position information.

20. The control apparatus of claim 13, wherein the instructions, when being executed by the one or more processors, cause the control apparatus to control a flight of a drone system based on the object GPS position information.
